(19) United States
(12) Patent Application Publication
(10) Pub. No.: US 2010/0300412 A1
(43) Pub. Date: Dec. 2, 2010

(54) Method for Optimizing Flow Performance of a Direct Injection Fuel Injector

(76) Inventors: Kevin R. Keegan, Hilton, NY (US); Charles W. Braun, Livonia, NY (US)

Correspondence Address: DELPHI TECHNOLOGIES, INC, M/C 480-410-202, PO BOX 5052, TROY, MI, 48007, US

(21) Appl. No.: 12/476,400

(22) Filed: Jun. 2, 2009

(51) Int. Cl. F02M 51/00

(52) U.S. Cl. 123/490

(57) ABSTRACT

A method for controlling a DI fuel injector relying on measurement of a engine operating parameter, preferably fuel pressure in an associated fuel rail. Regimes of low fuel injector flow require lowered fuel rail pressure, allowing lowered peak and hold currents that afford quicker closing. Under low flow conditions, a prior art fixed peak current exceeds the current required for rapid opening of the fuel injector, and a prior art fixed hold current exceeds the current required for holding the valve open for the full duration of the open window. In the present invention, the peak and hold currents, and optionally peak and hold voltages, are varied as functions of fuel rail pressure, either continuously or stepwise. The result is full function of a fuel injector over the full range of fuel flow requirements while also providing the quickest possible response under all flow conditions.

### TECHNICAL FIELD

The present invention relates to methods for controlling fuel injection in internal combustion engines; more particularly, to methods for controlling the timing of fuel injection in direct fuel injection engines; and most particularly, to a method for optimizing the flow performance of a direct injection fuel injector by varying the drive waveform as a function of pressure in the engine fuel rail or other performance parameters.

### BACKGROUND OF THE INVENTION

Direct injection (DI) of fuel from a pressurized fuel rail into engine cylinders is well known for both compression-ignited and spark-ignited internal combustion engines. To achieve injection, inlet fuel injector pressure from pressure in the fuel rail must be sufficient to overcome the compression pressure in the cylinder.

A fuel injector for a spark-ignition direct-injected engine typically is commanded by an injector driver at two successive levels of current: first, a peak current for getting the injector valve open quickly, and second, a hold current less than the peak current for holding the valve fully open for the required time against spring force and fuel pressure. At the termination of injection, the hold current is shut off, and the valve is closed by a spring within the injector as well as by the pressure of the fuel entering the injector. Thus, in a graph of valve pintle position as a function of time, the area under the curve is indicative of the total amount of fuel injected. If the hold current is insufficient to maintain the valve fully open for the desired period, the amount of injected fuel will be less than desired. Further, the closing rate is a function not only of the spring's constant but also of the size and rate of decay of the solenoid's magnetic field.

A problem in prior art fuel injector control is that a high dynamic range of fuel flow is required to meet demands for both very low fuel flow at low engine speeds or light loads and also very high fuel flow during peak engine power. Relatively large peak and hold currents are required during peak engine power demand at high fuel rail pressures, but such currents result in relatively slow closing rate because of the size of the corresponding magnetic field.

Recall that a fuel injector is essentially an open/closed valve that, when open, allows fuel to be forced from the fuel rail into the combustion chamber. A fuel rail may run at a typical pressure of about 100 bar. An injector does no “injecting” or pumping of its own. It is known to vary the pressure in the fuel rail with engine demand to help reduce the requirements of injector design by changing the time of the opening pulse to compensate for an injector's deviation from nominal. However, changing the current and/or voltage level output of the injector driver to take advantage of this varying pressure is not known in the prior art. Prior art fuel injector systems typically have a fixed peak current of about 11 amperes and a fixed hold current of about 3 amperes.

What is needed in the art is a method for varying the driver wave form as a function of pressure in the engine fuel rail, or other measured conditions such as engine temperature or coolant temperature as a surrogate for injector temperature, or battery voltage, which can change the hold chop waveform.

It is a principal object of the present invention to improve the accuracy of delivery of a DI fuel injector over the full dynamic range of fuel flow required by an internal combustion engine.

### SUMMARY OF THE INVENTION

Briefly described, a method for controlling a DI fuel injector in accordance with the present invention relies on measurement of an operating parameter, preferably fuel pressure in an associated fuel rail. Regimes of low fuel injector flow demand require only lowered fuel rail pressure, allowing lowered peak and hold currents that afford quicker closing. Under low flow conditions, a prior art fixed peak current of 11 amperes exceeds the peak current required for rapid opening of the fuel injector valve, and a prior art fixed hold current of three amperes exceeds the hold current required for holding the valve fully open for the full duration of the open window. In the present invention, the peak and hold currents are varied as a function of fuel rail pressure, either continuously or stepwise, and either linearly or not. The result is full function of a fuel injector over the full range of fuel flow requirements while also providing the quickest possible response under all flow conditions.

### BRIEF DESCRIPTION OF THE DRAWINGS

The present invention will now be described, by way of example, with reference is to the accompanying drawings, in which:

FIG. 1 is a schematic drawing showing a prior art control method for a fuel injector driver and a fuel injector;

FIG. 2 is a schematic drawing showing a control method in accordance with the present invention for a fuel injector driver and a fuel injector.

Corresponding reference characters indicate corresponding parts throughout the several views. The exemplification set out herein illustrates one preferred embodiment of the invention, in one form, and such exemplification is not to be construed as limiting the scope of the invention in any manner.

### DESCRIPTION OF THE PREFERRED EMBODIMENTS

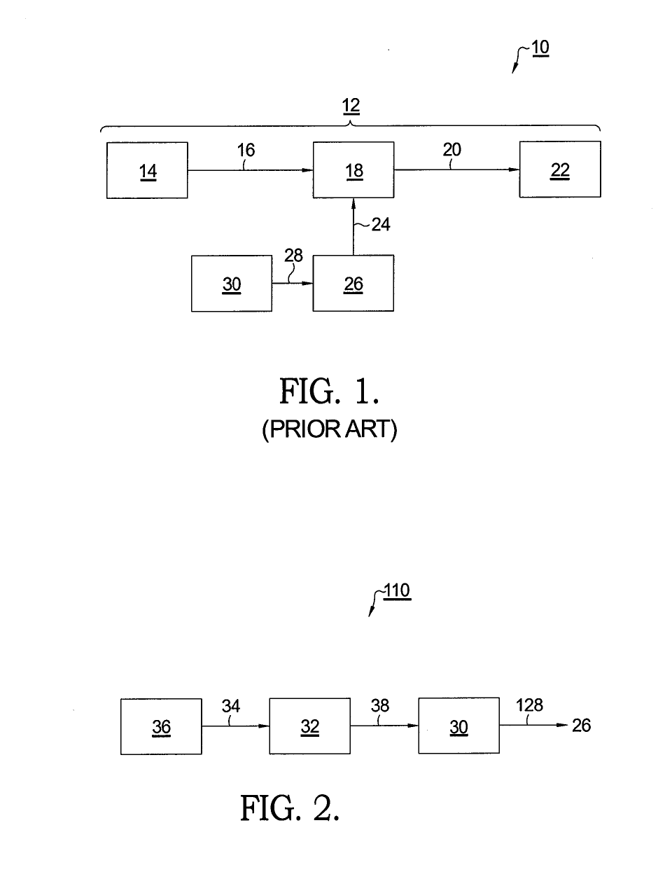

Referring to FIG. 1, in prior art control method 10 for a direct-injected internal combustion engine 12, a pressurized fuel rail 14 supplies pressurized fuel 16 to a fuel injector 18 which periodically injects fuel 20 into an engine combustion chamber 22. Fuel injector 18 responds to voltage and current inputs 24 from a fuel injector driver 26 which in turn is responsive to commands 28 from an Engine Control Module (ECM) 30. In the prior art, commands 28 are fixed such that peak current and voltage and hold current and voltage provided by driver 26 are invariant, although injection timing and length may be varied depending upon engine operating conditions.

Referring now to FIG. 2, ECM 30 continues to supply commands 28, modified in accordance with the present invention as commands 128 directed to, for example, peak current, peak current time, fast transition time, bypass time, peak voltage, hold current, hold voltage output, and combinations thereof. An algorithm 32 responsive to signals 34 from any or several engine operating parameter inputs 36 provides programming input 38 to ECM 30 for varying the timing, current, and/or voltage instructions in commands 128 to driver 26.

In prior art method 10, typical peak current is 11 amperes and hold current is 3 amperes in inputs 24. Corresponding voltages may be 50 volts and 12 volts, respectively. Pressure in fuel rail 14 is relatively high.

In present invention 110, under conditions of maximum engine power demand, the timing, current, and voltage conditions in commands 128 are preferably substantially the same as in the prior art, although voltage may be as high as 70 volts. Again, fuel rail pressure is high. However, as engine power demand is decreased (as may be expressed by any one or combination of known engine operating signals such as throttle position, manifold vacuum, engine temperature, inline fuel rail pressure, and engine speed), the pressure in fuel rail 14 may be reduced and the peak and hold targets in signal 128 may be proportionally reduced to, for example, peak current of 8 amperes and hold current of 2 amperes. Peak voltage may be about 40 volts. Preferably, the time length of the peak current is also shortened, for example from 0.5 milliseconds to 0.3 milliseconds, which enables a quicker closing response of fuel injector 18 for very small pulses as during idling, when the injector is shut off shortly after peak current is reached.

Preferably, algorithm 32 is programmed with one or more “look-up” tables of data relating optimum peak and hold currents and lengths as functions of signals 34 from engine operating parameter inputs 36. A currently preferred engine operating parameter input is line pressure in fuel rail 14. Preferably, signals 128 are continuously variable as a function of signals 34, although a step-wise response, for example, two steps, is also comprehended by the present invention.

Benefits conferred by the present invention are quicker fuel injector closing, smaller minimum linear pulse, higher dynamic flow range, and/or higher maximum operating pressure while maintaining the same operating performance at existing pressures.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

1. A method for controlling a fuel injector driver and fuel injector in an internal combustion engine, said injector comprising a solenoid and controllable between a fully off state and a fully on state with no non-transient intermediate states, comprising the steps of:
a) measuring at least one engine operating parameter;
b) varying at least one of peak current, peak current time, fast transition time, bypass time, peak voltage, hold current, hold voltage output, and combinations thereof from said fuel injector driver to said fuel injector in response to variations in said measured engine operating parameter.

2. A method in accordance with claim 1 wherein said at least one engine operating parameter is inline fuel rail pressure.

3. A method in accordance with claim 1 wherein said varying step includes use of lookup tables relating said at least one engine operating parameter to at least one of said peak current, peak voltage, hold current, and hold voltage.

4. A method in accordance with claim 1 wherein said varying is continuously variable.

5. A method in accordance with claim 1 wherein said varying is step-wise.

6. An internal combustion engine including a fuel injector driver and fuel injector operated in accordance with the method of claim 1.

7. An engine in accordance with claim 6 wherein said engine is selected from the group consisting of compression-ignited and spark-ignited.

8. An engine in accordance with claim 7 wherein said fuel injector is direct-injection.
